(19) United States
(12) Patent Application Publication
(10) Pub. No.: US 2009/0210296 A1
(43) Pub. Date: Aug. 20, 2009

(54) System and method for providing a normalized correlated real-time employee appraisal

(75) Inventor: Michael L. Goolden, Fairfield, CT (US)

Correspondence Address: Pamela L. Wingood;Ohlandt Greeley, Ruggiero & Perle, L.L.P., One Landmark Square, 10th Floor, Stamford, CT, 06901-2682, US

(73) Assignee: MLG SYSTEMS, LLC - DBA L7

(21) Appl. No.: 12/386,746

(22) Filed: Apr. 22, 2009

Related U.S. Application Data
(63) Continuation-in-part of application No. 11/537,370, filed on Sep. 29, 2006.

(51) Int. Cl. G06Q 10/00; G06F 17/30; G06F 17/40

(52) U.S. Cl. 705/11; 707/104.1; 707/E17.044

(57) ABSTRACT

A method and system for providing a performance evaluation of an at least one employee by a supervisor in an organization. The method and system provide for collecting a plurality of numerical performance goals data for the at least one employee and storing the plurality of numerical performance goals data in a database; collecting numerical business measures data related to the organization and storing the numerical business measures data in the database. Further, the method and system provide for normalizing the numerical performance goals data and the numerical business measures data to a common scale to generate normalized performance goals data and normalized business measures data. The method and system correlate the normalized performance goals data and the normalized business measures data; and determine a plurality of scores for the performance of the at least one employee, wherein each of the plurality of scores are based on the correlated normalized performance goals data and the correlated normalized business measures data. The method and system display the plurality of scores on a display screen, wherein the screen provides a chart that is a visual indication of the plurality of scores representing an overall score for the performance of the at least one employee.

### RELATED APPLICATIONS

The present application is a Continuation-in-Part Application of U.S. Patent Application Publication 2008/0082456, Ser. No. 11/537,370 filed on Sep. 29, 2006, the contents of which are incorporated herein by reference.

### I. BACKGROUND

A. Field of the Invention

The invention relates generally to a method and system for building and assessing an employee's real-time performance in an organization by normalizing numerical values of employee goals and responsibilities and correlating those goals and responsibilities with normalized business measures and project values.

B. Description of the Related Art

Managers are periodically presented with the responsibility of assessing and evaluating employee performance. Often such assessments are difficult due to lack of time, lack of metrics by which to objectively measure employee performance and fear of appearing too subjective and or critical. The problem is essentially complicated by not having real and identifiable numerical measurements that are normalized across an organization by which to accurately and objectively measure employee performance and growth based upon areas of responsibility.

By not having accurate means of measuring employee performance, overall business key areas may fail to grow as required because employee efforts are either misdirected and not integrated to relate to the organizations bottom line.

Additionally, companies often have strategy and prioritization disconnects; tactical execution and accountability disconnects; process, systems, communication, and control disconnects. The ability to evaluate employee performance is also compounded by lack of clear visibility to current strategic priorities across an organization and at different managerial levels of the organization. These issues do not provide managers or employees the mechanism by which employee performance can be easily and objectively monitored/evaluated in relation to organizational goals and measures.

Accordingly, there is a need for a system and method for collecting and normalizing company wide and employee specific objectives and goals to enable real-time comparison and evaluation of employee performance relative to company wide objectives.

### II. SUMMARY

The present disclosure provides for an appraisal system that normalizes business measures and project values and collected employee responsibilities and goals to a common numerical scale and correlates the business measures and project values and the employee responsibilities to obtain performance scores for the employee.

The present disclosure also provides for an appraisal system and method that correlates the normalized business measures and project values together with the employee responsibilities and goals to permit real-time scores/status of employee performance to be accessed with respect to the different goals and responsibilities.

A method for providing a performance evaluation of an at least one employee by a supervisor in an organization is provided. The method provides for collecting a plurality of numerical performance goals data for the at least one employee and storing the plurality of numerical performance goals data in a database; and collecting numerical business measures data related to the organization and storing the numerical business measures data in the database. The method further provides for normalizing the numerical performance goals data and the numerical business measures data to a common scale to generate normalized performance goals data and normalized business measures data; and correlating the normalized performance goals data and the normalized business measures data. The method further provides for determining a plurality of scores for the performance of the at least one employee, wherein each of the plurality of scores are based on the correlated normalized performance goals data and the correlated normalized business measures data; and displaying the plurality of scores on a display screen, wherein the screen provides a chart that is a visual indication of the plurality of scores representing an overall score for the performance of the at least one employee.

A system for evaluating an at least one employee in an organization includes a plurality of inputting devices for inputting employee performance goals data; and at least one database for collecting employee performance goals data and business measures data. The system further provides for a normalizing component for normalizing the employee performance data and the d business measures data to a common scale. A processor includes a correlating component for correlating the employee performance data and the business measures data. A display device that displays a plurality of graphical displays on a screen, wherein one of the plurality of displays represents an overall performance score of the at least one employee based on the correlated business measures data and the correlated employee performance data.

A computer readable storage media containing executable computer program instructions which when executed cause a processing system to perform a method including the following steps is provides. The steps include collecting a plurality of numerical performance goals data for the at least one employee and storing the plurality of numerical performance goals data in a database; and collecting numerical business measures data related to the organization and storing the numerical business measures data in the database. The method further includes normalizing numerical performance goals data and numerical business measures data to a common scale to generate normalized performance goals data and normalized business measures data; and correlating the normalized performance goals data and the normalized business measures data. The method further provides for determining a plurality of scores for the performance of the at least one employee, wherein each of the plurality of scores are based on the correlated normalized performance goals data and the correlated normalized business measures data; and displaying the plurality of scores on a display screen, wherein the screen provides a chart that is a visual indication of the plurality of scores representing an overall score for the performance of the at least one employee.

### III. BRIEF DESCRIPTION OF THE DRAWINGS

Other objects and advantages of the invention may become apparent upon reading the detailed description and upon reference to the accompanying drawings.

FIG. 1 is a flow diagram illustrating a method for assessing and improving the performance of an organization, in accordance with one embodiment.

FIG. 2 is a flow diagram illustrating a method for weighted-averaging business measures to determine a performance indicator for an organization, in accordance with one embodiment.

FIG. 3 is a flow diagram illustrating a method for weighted-averaging target values and projects according to their determined effectiveness, in accordance with one embodiment.

FIG. 4 is a flow diagram illustrating a method for weighted-averaging sub-business measures to determine the value of the business measure, in accordance with one embodiment.

FIG. 5 is a diagram illustrating a graphical representation of business measures and the performance indicator, in accordance with one embodiment.

FIG. 6 is a diagram illustrating alternative graphical representations of the values of business measures, in accordance with one embodiment.

FIG. 7 is a table showing a list of projects and a target value for a business measure, in accordance with one embodiment.

FIG. 8 is a block diagram illustrating an information handling system operable to assess the performance of an organization, in accordance with one embodiment.

FIG. 9 is a flow diagram illustrating a method for identifying and overcoming barriers to high performance for an organization, in accordance with one embodiment.

FIG. 10 is a flow diagram illustrating the components for building/establishing an employee appraisal system according to the present invention;

FIG. 11. Is a diagram illustrating a method for adding key measures to the an employee appraisal system according to an embodiment of the present invention;

FIG. 12 is a flow diagram illustrating the process for adding data files to an employee appraisal system according to the present invention;

FIG. 13 is a flow diagram illustrating the process for adding project files to an employee appraisal system according to the present invention; and

FIG. 14 is a schematic diagram illustrating the hardware components for an employee appraisal system according to the present invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiment. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

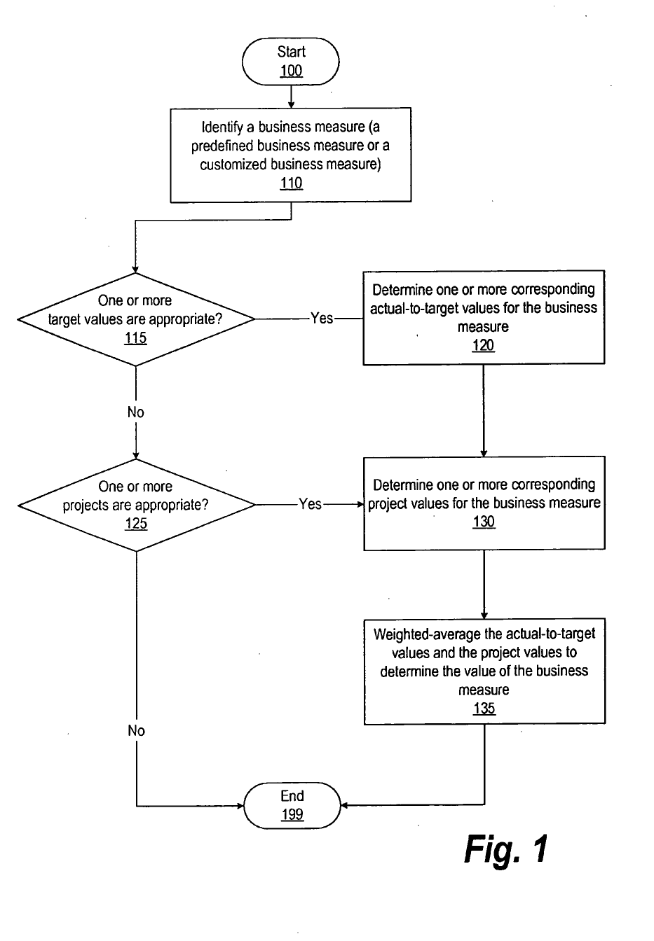

FIG. 1 is a flow diagram illustrating a method for assessing and improving the performance of an organization, in accordance with one embodiment. Processing begins at 100 whereupon, at block 110, a business measure is identified. In one embodiment, the business measure may be weighted-averaged with other business measures to determine a performance indicator for an organization. The business measure may be a predefined business measure or a customized business measure. In one embodiment, the total number of business measures may be limited to seven, as higher numbers of business measures may be difficult for an organization to process efficiently. As will be discussed below, sub-business measures, sub-sub-business measures may also be limited to seven for purposes of efficiency.

In one embodiment, predefined business measures are business measures that are preferably adopted as business measures across all organizations for use in assessing and improving the performance of the organization. Predefined business measures may include revenue (such as gross sales and other sales-related measures and activities), income (such as finance-related, CFO/controllership-related, and tax-related measures and activities), employee (such as human resources-related measures and activities), customer (such as marketing-related measures and activities), and compliance (such as internal and/or external vital process control areas related measures and activities). In one embodiment, the number of predefined business measures may be limited to these five business measures.

In one embodiment, customized business measures are business measures that may be customized for each particular organization; chosen to meet the specific needs and characteristics of the particular organization. The customized business measures may be business measures in business areas that drive key results in those business areas. Customized business measures may be, for example, profit-per-store, quality of particular products or services, partner status, new products or services, etc. In one embodiment, the number of customized business measure may be limited to two.

A determination is then made, at decision 115, as to whether one or more target values are appropriate for the evaluation of the business measure. A target value represents an optimum, desired target value for a business measure to reach that, for example, a manager of a business unit or department establishes. If a target value is determined as appropriate for the particular business measure, decision 115 branches to block 120 where a corresponding actual-to-target value is determined. In one embodiment, the actual-to-target value may represent a ratio of the actual (current in some cases) value to a target (desired) value for the business measure. Accordingly, a ratio may be either above or below 1 depending upon the percentage of completion of the target value relative to the time remaining to complete the target value. Processing subsequently continues to block 130. The actual-to-target value may be expressed as a percentage or, as will be discussed below, the actual-to-target value may be assigned a number from a numerical scale. The number from the numerical scale represents a normalized value of the ratio that enables comparison to other such normalized values.

Returning to decision 115, if no target values are appropriate, decision 115 branches to decision 125 where a determination is made as to whether one or more projects are appropriate for the business measure. A project may be any task with the goal of increasing the value of the business measure. For example, in the case of the revenue business measure, a sales training program may be a project intended to increase the value of the revenue business measure. It should be noted that a project may affect the value (and thus be part on more than one business measure. Thus, a particular project or the degree of completion of a project may impact for example, the revenue business measure and the compliance business measure. If no projects are appropriate (or needed) for the business measure, decision 125 branches to 199 where processing ends.

If one or more projects are determined to be appropriate, decision 125 branches to block 130 where one or more corresponding project values for the business measure are determined. In one embodiment, a project value represents how on-time the completion of a project is. For example, the project value may be a ratio of a number indicating where the completion of a project is (which may be expressed as a percentage) and a number indicating where the completion of a project should be (which may also be expressed as a percentage) according to the project's start and end dates. For example, according to one embodiment, the expected completion of a project over time (in terms of the current time, the start time, and the expected end time) may be given by:

Expected Completion=(t_{current}−tₛₜₐᵣₜ)/(t_{end}−tₛₜₐᵣₜ).

The actual completion value may be manually entered and updated by the user at any given time or it may be determined and entered/updated by other means. The actual completion may be then compared to the expected completion to determine the project value. In one embodiment the project value may then be the ratio of actual to expected completion: Project Value=(Actual Completion)/(Expected Completion). The project value may also be expressed in a numerical scale, such as a scale from one to seven, that represents a normalized value of the ratio.

In one embodiment, in order to convert either the ratio computed for the actual-to-target value or the project value into the one to seven scale, the following formula may be used:

Scaled Value=FLOOR(ratio*5+1),

where FLOOR is a rounding function that rounds a number to the nearest integer that is smaller than the number.

At block 135, the actual-to-target values and the project values are weighted and then summed (averaged) to determine an overall value for the business measure. Project values and actual-to-target values may be weighted differently according to the importance of each and/or a prediction as to the effectiveness of each. The weights similar to the actual values can be adjusted according to the business measure. Processing subsequently ends at 199.

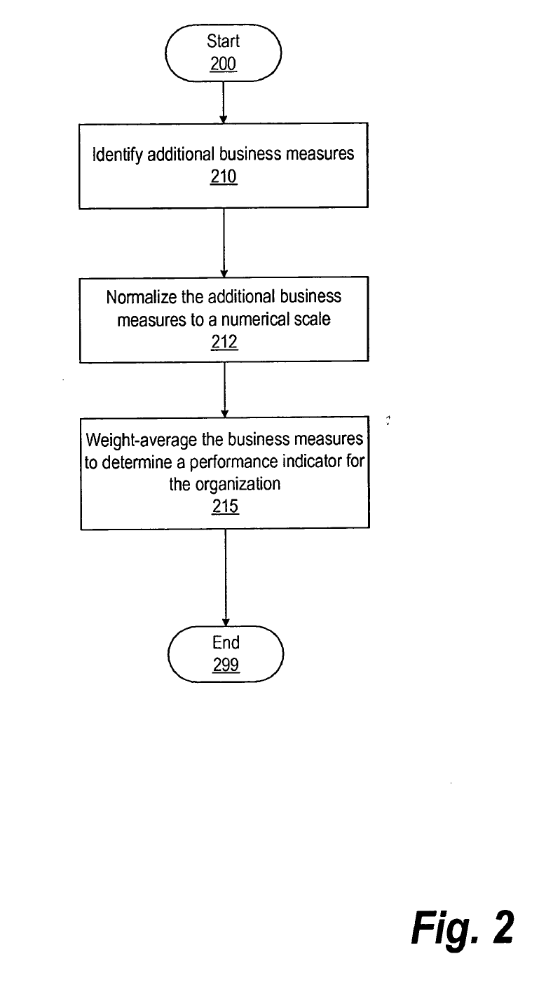

FIG. 2 is a flow diagram illustrating a method for weighted-averaging business measures to determine a normalized performance indicator for an organization, in accordance with one embodiment. Processing begins at 200 where, at block 210, additional business measures are identified. In one embodiment, the total number of business measures may be limited to seven, if a normalizing scale of seven is utilized.

At block 212, the business measures are normalized to a common numerical scale. Having a common numerical scale for the business measures facilitates immediate and more effective comparison of the status of each of the business measures relative to each other. In the present disclosure, each of the business measures may be normalized to a numerical scale from one to seven. While a scale of one to seven is used in the instant disclosure, the business measures and other project values in the present disclosure may be normalized to a scale having as large or as small a range as necessary depending upon the degree of resolution desired between different numbers on the scale.

At block 215, the business measures are weighted-averaged in order to determine an overall performance indicator for the organization. In one embodiment, the various business measures are first weighted according to each business measure's importance, and then the business measures are averaged to determine the overall performance indicator for the organization.

Processing subsequently ends at 299.

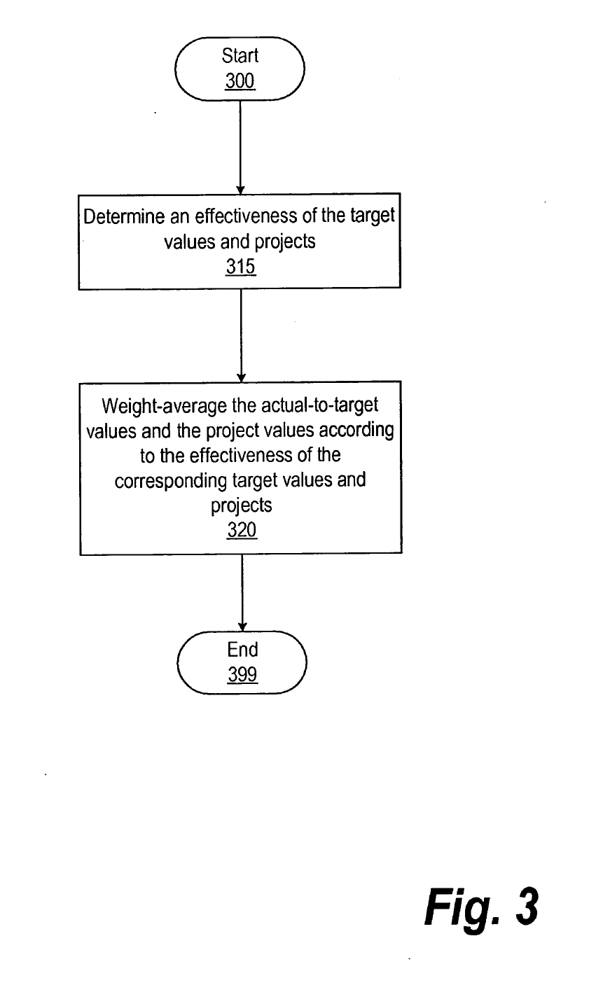

FIG. 3 is a flow diagram illustrating a method for weighted-averaging target values and projects according to their determined effectiveness, in accordance with one embodiment. Processing begins at 300 whereupon, at block 315, the effectiveness of the target values and projects is determined. In one embodiment, the effectiveness may be a prediction or a determination of the impact of each target value or project on the business measure. The effectiveness may be used in the computation, for example, of the weight to be given to each target value and project when averaging the actual-to-target values and the project values to determine the value of a business measure.

At block 320, the actual-to-target values and the project values are weighted-averaged together to determine the value of the business measure according to the effectiveness of each corresponding target value or project. Other considerations may also be used when determining the weight to be given to each of the values.

Processing subsequently ends at 399.

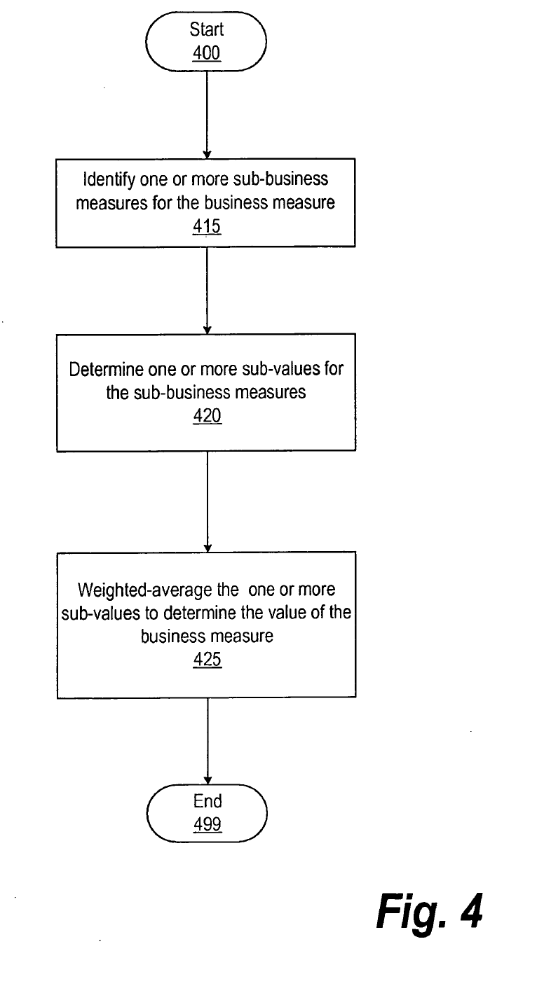

FIG. 4 is a flow diagram illustrating a method for weighted-averaging sub-business measures to determine the value of the business measure, in accordance with one embodiment. Processing begins at 400 whereupon, at block 415, one or more sub-business measures are identified. In one embodiment, one or more of the business measures may be divided into sub-measures to better facilitate the computation of the value of the business measure. It should be noted that, if considered necessary, each sub-business measure may be divided into sub-sub-business measures, etc. In one embodiment, the number of sub-business measures, sub-sub-business measures, etc. may be limited to seven.

At block 420, one or more sub-values corresponding to each of the sub-business measures is determined. In one embodiment, these values may be determined using a process similar to the process used to determine the values of the measures. That is, sub-actual-to-target values and sub-project values may be introduced and computed as needed to determine the value of each sub-business measure.

At block 425, the one or more sub-values are weighted (according to the importance and/or effectiveness of each, for example), and then the sub-values are averaged (summed) to determine the value of the business measure. In the cases where sub-sub-measures, etc. are used, a tree-like process may be used to first compute the values of the sub-sub measures, then the values of the sub-measures, then the values of the business measures, and finally the overall performance factor of the organization.

Processing subsequently ends at 499.

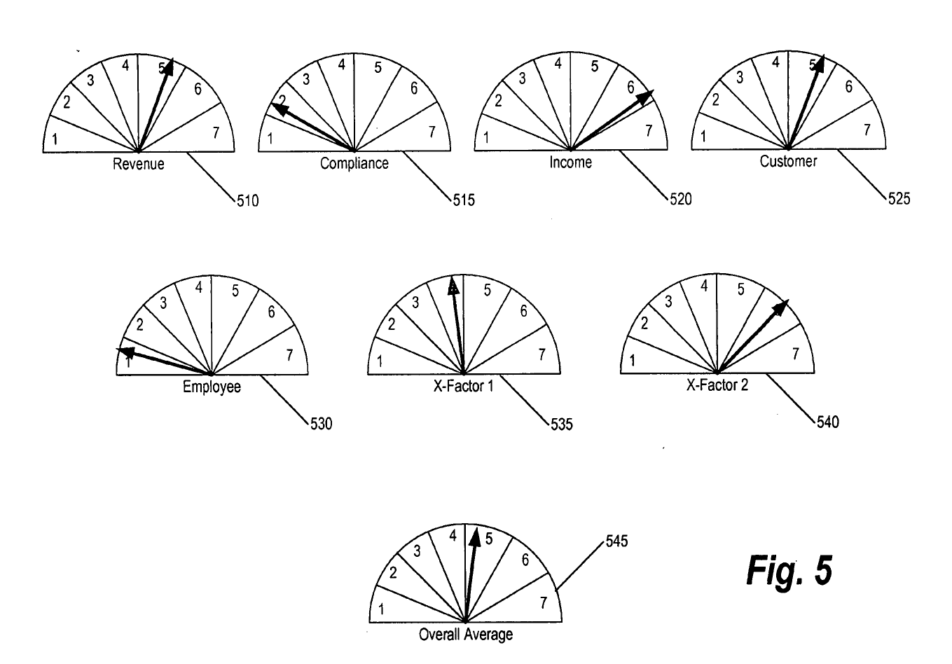

FIG. 5 is a diagram illustrating a graphical representation of business measures and the performance indicator, in accordance with one embodiment. In this example, graph 510 represents the revenue business measure, graph 515 the compliance, graph 520 the income, graph 525 the customer, and graph 530 the employee business measure. Graphs 535 and 540 represent the two customized business measures, which, in one embodiment, are custom-chosen for each organization. Graph 545 is a graphical representation of the overall performance indicator for the organization. Each of the graphs includes a scale from one to seven and an arrow indicating the value of the business measure and the value of the performance indicator. In one embodiment, each of the number scales may also be color (or pattern, etc.)-coded to better indicate the value that each graph depicts. For example, the values 0-3.9 may be colored red, 4.0-5.9 may be colored yellow, and 6.0 and above may be green.

In one embodiment, the results may be presented to a user in real time (to a computer's personal computer, for example) and may be arranged to appear either in a separate window, on the user's desktop, in the user's task bar, etc. Other features may be included as part of the graphs, such as the ability to click on a portion of the graph in order to obtain additional details. For example, clicking on the revenue business measure may provide additional details on the status of the quantities that are being used to compute the value for the revenue business measure.

In another embodiment, all the results (as well as all the sub-results) may be archived in order to facilitate the system's learning from past correlations (such as the correlation between projects and performance increase). Such detailed archiving can allow users to see a snapshot of the organization at any date in the past in a very efficient manner and can allow the users to better design future strategies based on the historical snapshots. This also provides for immediate compliance verifications.

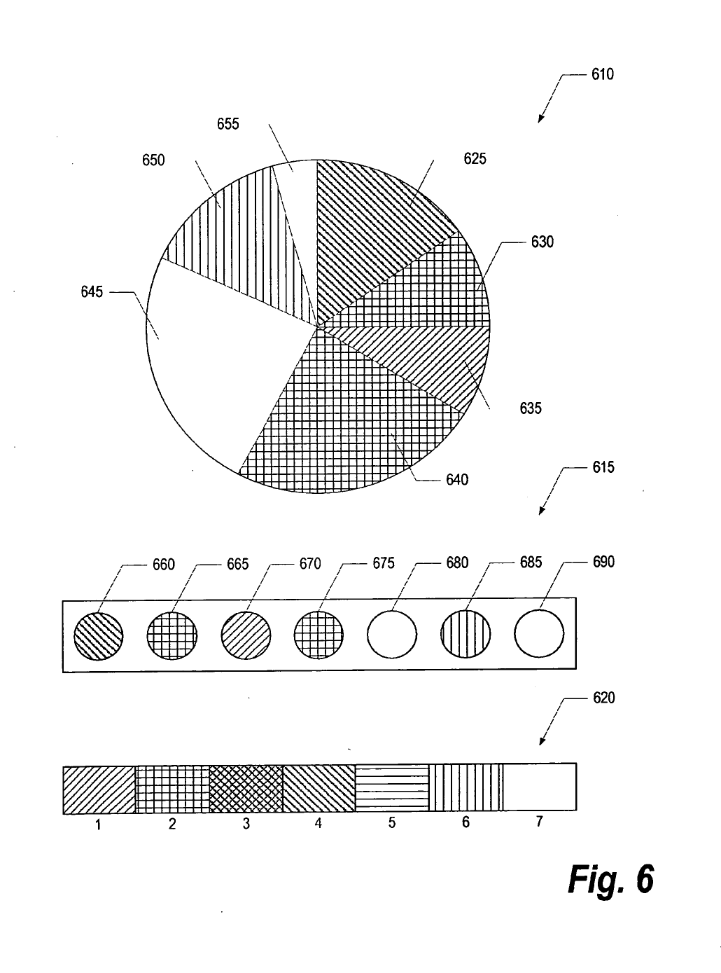

FIG. 6 is a diagram illustrating alternative graphical representations of the values of business measures, in accordance with one embodiment. It should be noted that this chart may also be used to represent the values of sub-business measures, sub-sub-business measures, etc. Scale 620 indicates which values are represented by which patterns (or colors if colors are used). Each of the numbers 1-7 is represented by a different pattern (or color) as seen by the scale.

Pie chart 610 is one alternative representation of the values of each of the business measures. Each of the seven business measures in this example is represented by each section 625, 630, 635, 640, 645, 650, and 655 of the pie chart. The pattern (or color) of each section indicates the value of each of the business measures, in accordance to scale 620. The size of each section represents the weight (which may also indicate the importance) given to each of the business measures. In this example, business measures 640 and 645 appear to have high weights whereas business measure 655 is given a low weight.

Chart 615 represents another alternative representation (in the form of a graph or a toolbar) of the business measures values. Each of the seven business measures is represented by circles 660, 665, 670, 675, 680, 685, and 690. The pattern (or color) of each circle indicates the value of each of the business measures, in accordance to scale 620. In one embodiment, an additional circle may be present to represent the overall performance factor of the organization—a weighted-average of all the business measures.

In one embodiment, the results may be presented to a user in real time (to the user's personal computer, for example) and may be arranged to appear either in a separate window, on the user's desktop, in the user's task bar, etc. Other features may be included as part of the graphs, such as the ability to click on a portion of the graph in order to obtain additional details. For example, clicking on the revenue business measure may provide additional details on the measures used to compute the value for the revenue business measure. Additional details may also be provided to the user when the user floats a pointing device, such as a mouse, over different portions of the graph/toolbar.

In one embodiment, the graph/toolbar may be provided to a selected group of employees or to all of the employees of the organization in order to make the employees across the whole organization aware of the status of the performance of the organization, facilitating greater awareness of the goals and direction of the organization.

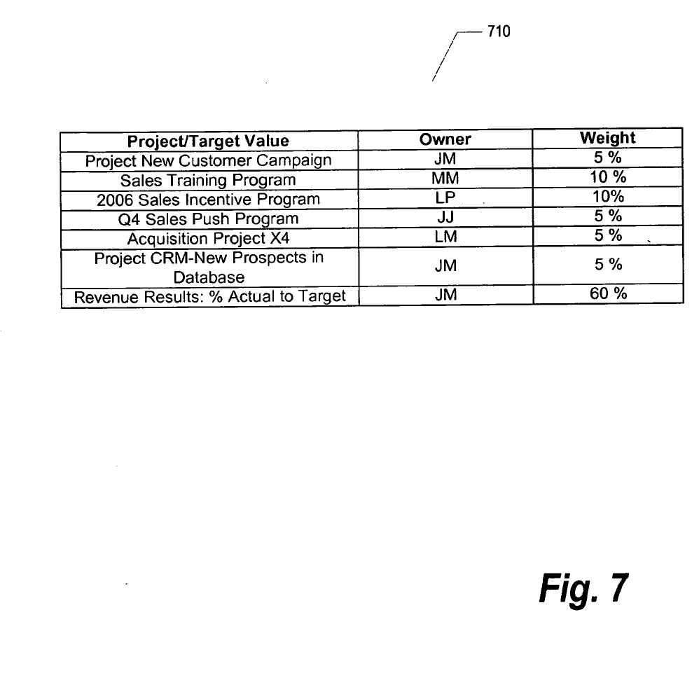

FIG. 7 is a table showing a list of projects and a target value for a business measure, in accordance with one embodiment.

Table 710 includes a column with the name/description of each project/target value, a column that indicates the user responsible for the project/target value (owner), and a percent column indicating the weight to be given to each project/target value during the averaging/summation. In the example shown, the business measure revenue is shown.

In one embodiment, the weights for each project/target value are chosen in accordance to the importance/effectiveness of each project/target value. An owner may be assigned to each project/target value for accountability purposes. If the value of a project/target is not satisfactory, for example, a manager, CEO, etc. will know whom to hold accountable for that particular project's/target's unsatisfactory performance.

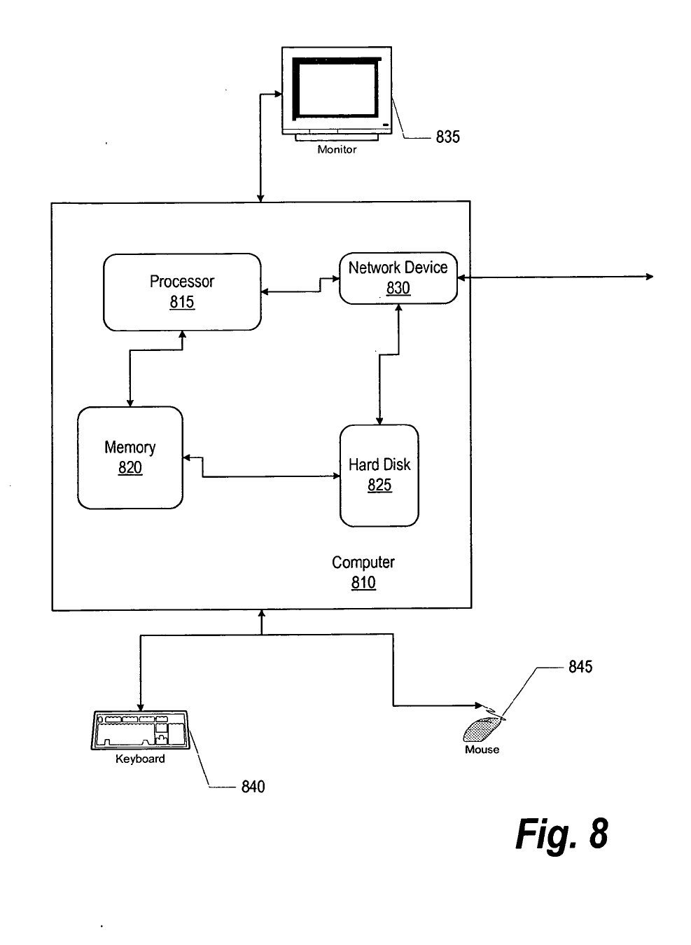

FIG. 8 is a block diagram illustrating an information handling system operable to assess the performance of an organization, in accordance with one embodiment.

The information handling system may include software or hardware or both in order to be operable to perform the function(s) claimed herein. In the example shown in the figure, the information handling system includes memory 820, processor 815, hard disk 825, input/output/network unit 830, keyboard 840, pointing device 845, and display monitor 835. Other configurations for the information handling system are possible.

It should also be noted that the system may be accessed over a network (such as the internet) through a browser (such as a web browser) either for updating data or monitoring purposes. A user need not have a particular application installed on the user's personal computer. Such a web-based system would be more easily accessible by more people in an organization.

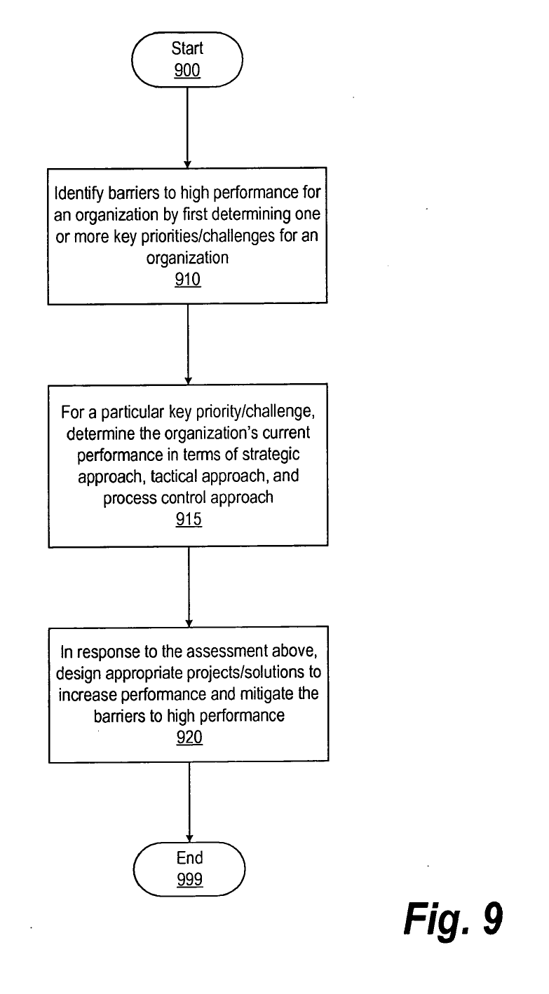

FIG. 9 is a flow diagram illustrating a method for identifying and overcoming barriers to high performance for an organization, in accordance with one embodiment.

Processing begins at 900 whereupon, at block 910, barriers to high performance are identified for an organization by first determining one or more key priorities/challenges for that particular organization. For example, a key priority/challenge for a particular organization may be a certain corporate acquisition.

At block 915, for a particular key priority/challenge, a determination is made as to the organization's current performance in terms of strategic approach, tactical approach, and process control approach. The strategic evaluation may include, for example, examining the quality of strategic initiatives relative to this area and the prioritization and focus of this area throughout the business. The tactical evaluation may include, for example, examining the tactical execution delivered on time of key tasks relative to this area and the accountability of individuals on key projects relative to this area. The process control approach may include, for example, examining the process and systems controls relative to this area, the communication and awareness relative to this area, and the alignment and team effort relative to this area. In one embodiment, each item may be rated on a scale from one to seven.

At block 920, in response to above assessment, one or more appropriate projects/solutions are designed to increase the performance and mitigate the barriers to high performance. Processing subsequently ends at 999.

In addition to the prior capabilities, the present invention can also be used to build an employee appraisal system 1000 that is usable by members selected in an organization to identify and track the current performance of an employee relative to company business measures supported by the employee and specific tasks related to projects that are assigned to that employee. Further, system 1000 is accessible by not only the employee's direct supervisor, but also by other managers whose projects and/or tasks the employee may have responsibility. All measures of the employee and the business measures to which the employee contributes or supports are normalized for ease of comparison and to eliminate any biases for complete objectivity.

In addition to business measures or project values being normalized for purposes of comparison, they are also correlated with one another. Correlation means that there may be mathematical relationships between normalized business measures and project values that are represented numerically. As such, business values and project values may be related either directly or indirectly, or be interdependent or have a causal relationship. For example, an increase in a project value such as the completion of a sales training project may result in an increase in a business measure, such as revenue. Thus, correlation refers to a relationship in which, in the example provided, the business measures and project values are not entirely independent of each other.

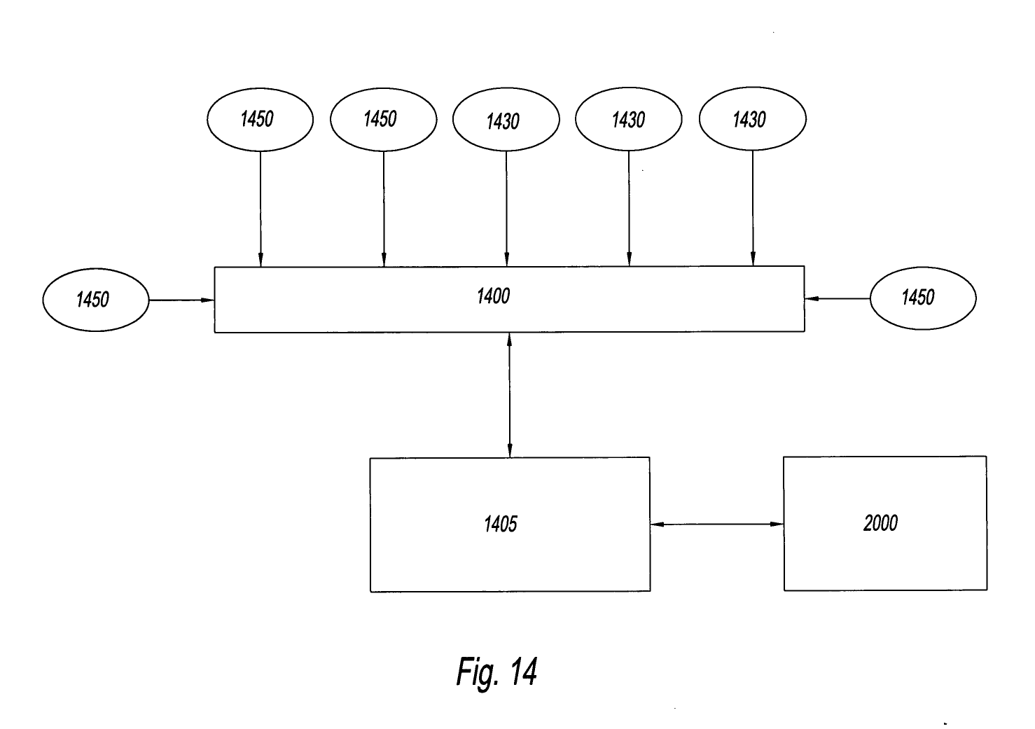

Significantly, the employee also has direct access to the appraisal system. The interactive and dynamic system 1000 permits the employee and others rapid and real-time access to the employee's progress towards supervisor identified goals during a particular time period and progress toward achieving such goals. Appraisal system 1000 is implemented, executed and updated by software programs and applications that together with relational database 2000 of FIG. 14 enable system operation. Additionally, the employee can add achievements/progress towards his goals and monitor his progress so that others may have visibility towards his progress as well. The advantage of system 1000 is derived from the fact that normalized values representing the business are correlated with the normalized values representing employee performance to permit real-time status of employee performance to be assessed.

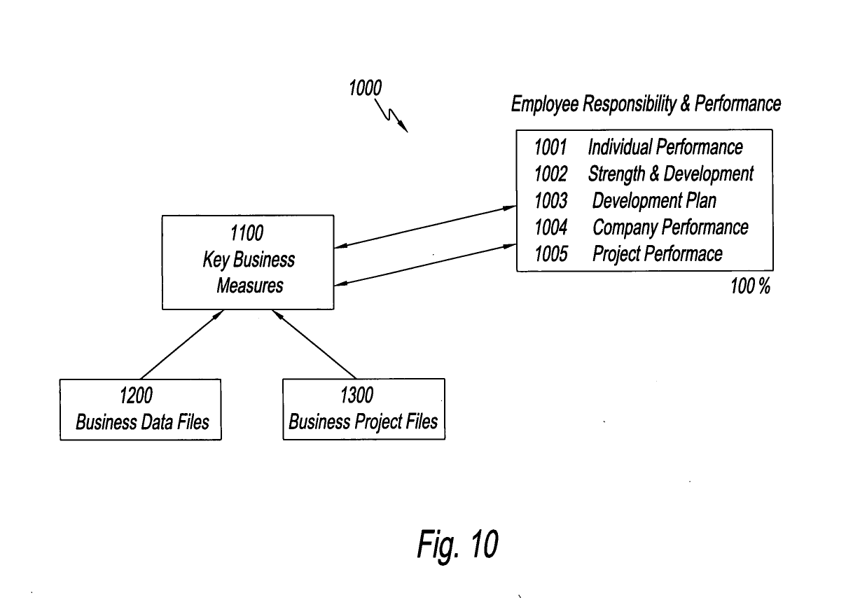

The process of building the appraisal system 1000 will now be discussed with reference to FIGS. 10 and 14. System 1000 includes relational databases 2000 into which data fields directed to a particular employee or group of employees are populated by a supervisor. Generally, system 1000 includes employee-specific files that are directed to employee responsibility and performance (modules 1001-1005) and additional relational data bases 2100 directed to key business measures 1100, business data files 1200 and business project files 1300, addressed below that must also be populated for an employee evaluation to be executed. It is to be understood that key business measures 1100, business data files 1200 and business project files 1300 must be contain inputted information and data for the appraisal system for a selected employee or group of employees to be operational. Company performance module 1004 and project performance module 1005 are interrelate and correlate employee performance to the overall company objectives and goals.

The process of building the key business measures 1100, business data files 1200 and business project files 1300 will now be discussed.

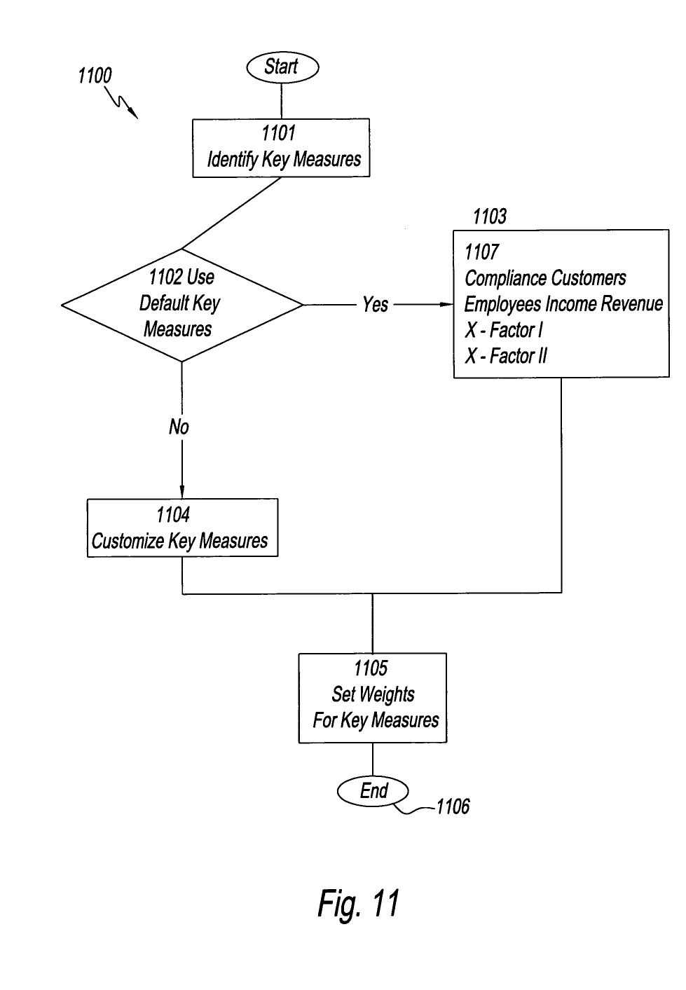

Referring to FIG. 11, key business measures component 1100 is built by the supervisor identifying and inputting key measures at step 1101 for a company, group or department. Supervisor decides to either customize measures or to use default parameters at step 1102. If supervisor chooses to use default parameters at step 1103, system 1000 includes at most seven default parameters 1107: compliance, customers, employees, income, revenue, and two additional factors. Alternatively, supervisor can choose to select customized measures at step 1102 that more accurately describe the key business measures for the particular group, company or department. Supervisor assigns weights to each of the seven parameters as they relate to the company's performance objectives. The sum of the weights of key business measures 1107 must total 100%. Key measure component 1100 enables appraisal system 1000 to mathematically assign importance of particular default parameters 1101 a relative significance to other parameters for later computation. In addition to key business measures being established in component 1100, sub-measures may also be established. Key measures component ends at step 1106.

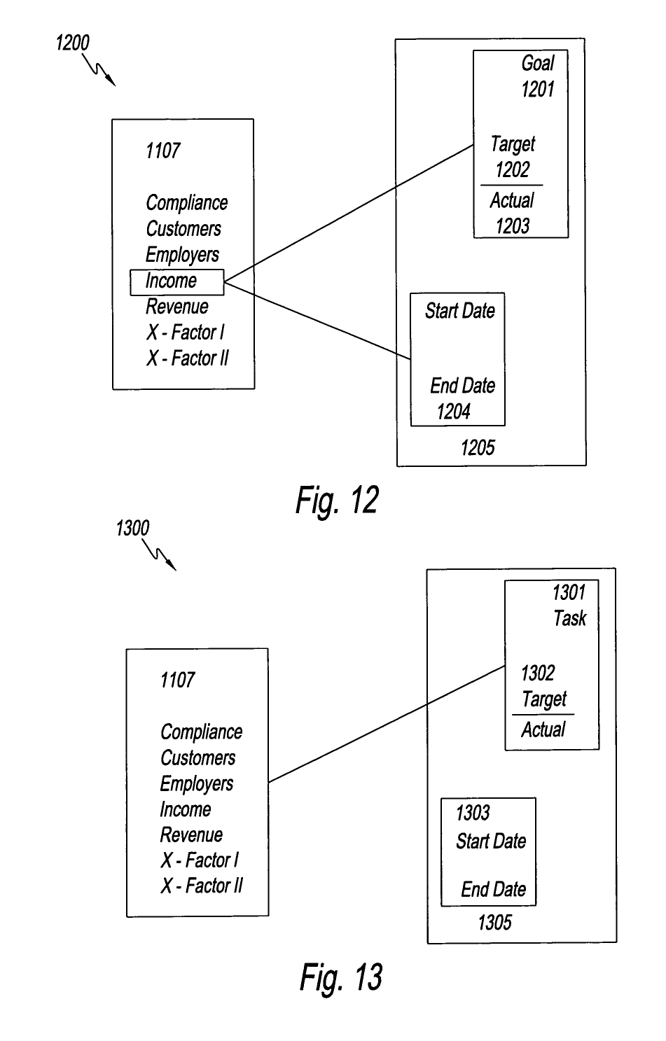

Referring to FIG. 12, business data files component 1200, is shown. Component 1200 permits supervisor to add numerical datafiles 1205 to describe numerical goals 1201 that support key measures 1107 from step 1103 of FIG. 11. Additionally, supervisor can add employee and start end finish dates for achieving goals for an employee. For every or some of the seven default business measures 1107 (or customized measures of step 1104), supervisor can add data file 1205 by establishing a numerical datapoint for a numerical goal 1201 and insert start date and finish date to establish a time period 1204 for numerical goal 1201 to be achieved. Numeric goal 1201 can be a dollar amount, a percentage point or a number of projects sold for the project, that relate to business measure Income, for example. Each goal 1201 has a target value 1202, which a supervisor would like to achieve, and an actual value 1203, that represents a real value, of units sold for example for a particular point in time. The numerical datafiles are all normalized.

During time period 1204, the employee may update actual value 1203 of goal 1201. Significantly, when the employee adds sales data, for example, to the business data file component 1200, system 1000 automatically changes a score for that particular module. The score is a normalized value determined on a scale from 1 to 7, with seven representing the highest achievement or 120% of the goal. Score is a ratio of target-to-actual completion of goal 1201 based on the scale of 1 to 7. For example, if the employee was at a half-way point of achieving goal 1201, the score would be 3.5, representing 50% if the time period for goal achievement was also at a half-way point. Were the goal approximately 75% completed during the same time period, the score would be greater than 3.5, reflecting a higher level of achievement in a shorter period of time. Supervisor can add up to seven data files 1205 to quantify goals 1201 associated with each of the seven key measures 1107 added from FIG. 11 above.

Referring to FIG. 13, project component 1300, is shown. Project component 1300 permits projects 1305 that directly related to the enhancement of seven key business measures 1107 to be added, prioritized and tracked. Projects 1305 are defined by predetermined numerical milestones that are represented by target and actual values. Projects 1305 also have a specific time frame for completion 1303. Further, project component 1300 permits a manager to assign an employee a particular task, so that employee accountability will be possible. For example, for the business measure Revenue, project 1305 may have a task 1301 to sell a specific number of units, a target 1302, of an item within a particular time period 1303. The supervisor can provide numeric values for both the number of units to be sold as well as the time period for completion of that task. System software calculates a score based on one to seven that indicates the degree of completion of the task for the specified time period. Again, as in the prior example, a score can be provided. The supervisor can also assign a weight to that task for the particular project to which the task is related. The weight to be added to the task represents the value/importance of the task to the particular goal for the business parameter. For example, if there are five tasks for a project 1305, they must add up to 100%. Each project 1305 for a business area 1107 can have up to seven tasks. Significantly, the employee can also provide input to the particular task/project module as he progresses towards goal achievement. As the employee updates his goals, a normalized score representing his progress towards his goal is calculated to provide a normalized representation of his progress. Multiple tasks can be added to a project file for each business area. Different tasks can contribute to different business measures.

After key business measures 1100, business datafiles component 1200 and project component 1300 are populated and entered into database 2000 of system 100, the employee appraisal can commence. The supervisor selects the name of an employee for whom an appraisal is to be executed. The supervisor must then select goals for the employee. Specific goals are entered into module 1001. Specific goals would be individualized job objectives for the employee. A strength and development module 1002 identifies particular talents and abilities that the employee possesses. Development plan module 1003 identifies those areas in which the employee may need further training or assistance to benefit job performance. The supervisor enters this information and selects a time period that the appraisal covers.

In company performance module 1104 and project performance module 1105, supervisor correlates employee specific measures from modules 1001 through 1003 above, to specific key business measures from key business measure component 1100 and to specific files from modules 1200 and 1300, discussed above. By actually connecting the fields associated with a particular employee to key business measures 1100, business data files 1200 and business project files 1300, employee performance can be correlated to overall business performance. For example, were employee able to exceed a particular sales goal or generate a certain number of clients, those increased numbers would be reflected in the overall business measures 1100 for the company, if the supervisor selected these particular modules. In module 1104, the employee is able to update his own performance on particular projects. In this way, the employee actually helps to build his own appraisal and permits him to receive real-time feedback and to provide progress to others who may view his appraisal during the appraisal time period. When employee adjusts his goals, a normalized score is automatically generated that reflects the performance of the employee. Supervisor adds weights to several performance and responsibility area modules 1101 through 1105 for the employee. The weights of the several areas equal 100%.

Referring again to FIG. 10, company performance module 1104 allows the supervisor to align the employee's performance to particular company wide business parameters 1107 that include areas that are associated with the employee. Specifically, as supervisor builds employee appraisal 1000, he selects key business measures 1107 for which employee has responsibility. As supervisor builds employees evaluation, he can select those parameters that align with the employees responsibilities. These business measures were discussed above in reference to module 1100 of FIG. 11.

Similarly, project performance module 1005 from system 1000 allows the supervisor to align employee performance with specific projects for which the employee has responsibility that support key business measures 1107 during evaluation period. As the supervisor builds appraisal, he tracks the performance of projects for which the employee has personal responsibility during the appraisal/evaluation period. permits employee to add numerical achievements to a particular project and permits others to view the employee progress with regard to particular project goals.

The database 2000 contains data that is normalized from modules 1101 to 1105 to be correlated with normalized data in databases directed to key business measures 1100, business data files 1200 and business project files 1300. In this way, the employee performance is correlated with specific business related files to provide a real-time status of employee performance on for example a specific project for which the employee has responsibility.

After the supervisor has inputted all of the appropriate goals into system 1000, employee acknowledges the supervisors goals and the evaluation period is able to commence. During the evaluation period, the employee can provide updates to system 1000 that would automatically update his progress and be indicated using the normalized scale, on a scale of for example, from one to seven. The automatic updating features provides real-time status of employee performance during the evaluation period.

By using system 1000, employee can also provide a self appraisal that would incorporate his achievements and expectations relative to his supervisor's goals. The supervisor can also comment on the employees progress with regard to modules 1001 through 1005 described above. Additionally, other supervisors for example, could also view the employees appraisal or add comments or suggestions to the appraisal for talks that were related to their areas of responsibility.

Appraisal system 1000 is comprehensive and dynamically inter-connected to all company measures and project goals and employee related business areas and goals for real-time employee performance assessment. In addition to modules 1001 through 1005 being correlated with key business measures and business files via key business measure module 1100, business data files 1200 and business project files 1300, modules 1001 and 1005 are also normalized to those same files.

Significantly, the scores based on the 1 through 7 scale for particular tasks are readily viewed and tracked by the employees direct supervisor, other specified managers and the employee himself. The employee who is being appraised or evaluated can update his progress during the time period for which the evaluation is sought. The score, based on 1 through 7, in this example, is and updated immediately upon new actual data being received or modified during the appraisal period.

After all input has been received by the system 1000, the supervisor and employee may view the system together. The appraisal system 1000 permits the supervisor and employee to view a monitor and observe the appraisal of system 1000 from different perspectives. System 1000 can show an overall normalized employee score, a normalized score representing achievement in each of area 1001 through 1005, or performance on particular projects, as examples. For example, they may look at different time points of the appraisal to obtain a snap-shot/screen-shot of different days or weeks during the appraisal period. The screen shot of the day or time period would reflect the normalized score for each of performance and responsibility modules 1001 through 1005 for the employee with the associated normalized score or value. Each score for an employee in any area is a normalized value that is correlated with other normalized values from the business measures database and the project values database.

FIG. 14 is a diagram illustrating an information handling system operable to support the employee performance appraisal system according to the present invention. The appraisal system may include software or hardware or both in order to be operable to perform the function(s) claimed herein. In the example shown in the figure, the appraisal system includes an area network 1400, work station 1410, server 1405, display monitors 1430. Applications and algorithms for executing appraisal system are available via network 1400 so that system subscribers may have ready access to appraisal system. System 1000 also includes one or more input devices such as but not limited to personal devices 1450 devices such as phones, keyboards. Significantly, system 1000 includes a relational database 2000 to receive all inputted data and datafiles that are interconnected to provide correlation of files. By having system 1000 interface with personal devices 1450, the employee being evaluated and managers throughout the company can not only have immediate access to the system, but also offer immediate input to the system to observe the status of particular business measures or projects related to a particular employee. Additionally, the employee can observe his progress relative to established target goals during a particular time period. Other configurations for the information handling system are possible.

It should also be noted that the system may be accessed over a network (such as the internet) through a browser (such as a web browser) either for updating data or monitoring purposes. A user need not have a particular application installed on the user's personal computer. Such a web-based system would be more easily accessible by more people in an organization. Additionally, potential subscribers to the appraisal system may access the software via a server and pay a periodic fee for its use. Thus, the potential subscriber need not have an appraisal system for its employees hosted on its own server or internal networks.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

I claim:

1. A method for providing a performance evaluation of an at least one employee by a supervisor in an organization:
collecting a plurality of numerical performance goals data for the at least one employee and storing the plurality of numerical performance goals data in a database;
collecting numerical business measures data related to the organization and storing the numerical business measures data in the database;
normalizing the numerical performance goals data and the numerical business measures data to a common scale to generate normalized performance goals data and normalized business measures data;
correlating the normalized performance goals data and the normalized business measures data;
determining a plurality of scores for the performance of the at least one employee, wherein each of the plurality of scores are based on the correlated normalized performance goals data and the correlated normalized business measures data; and
displaying the plurality of scores on a display screen, wherein the screen provides a chart that is a visual indication of the plurality of scores representing an overall score for the performance of the at least one employee.

2. The method of claim 1 wherein the numerical business measures data are a plurality of different measures for the organization.

3. The method of claim 2, wherein the display further provides for a plurality of charts, wherein each of the plurality of charts for the at least one employee is represents a score that is based on one of the plurality of different business measures.

4. The method of claim 2, wherein the plurality of different business measures are based at least on organization income, organization revenue, organization customers and organization compliance.

5. The method of claim 1, wherein the plurality of different numerical performance goals data comprise individual performance goals, strength and development goals, development goals, individual company performance goals and project performance goals.

6. The method of claim 1, wherein the numerical business measures data comprise key business measures data and project business files data.

7. The method of claim 6, wherein the key business measures data and the project business files data are correlated and normalized data.

8. The method of claim 1, wherein each of the plurality of different numerical performance goals and weighted relative to others of the plurality of different numerical performance goals to sum to 100%.

9. The method of claim 1, wherein the scale ranges from 3 to 7.

10. The method of claim 1, wherein the numerical business measures data are inputted in the database by a cell phone, a hand-held personal device of a keyboard.

11. The method of claim 1, wherein the at least one employee is a plurality of employees.

12. A system for evaluating an at least one employee in an organization comprising:
a plurality of inputting devices for inputting employee performance goals data;
at least one database for collecting employee performance goals data and business measures data;
a normalizing component for normalizing the employee performance data and the business measures data to a common scale;
a processor comprising a correlating component for correlating the employee performance data and the business measures data;
a display device that displays a plurality of graphical displays on a screen, wherein one of the plurality of displays represents an overall performance score of the at least one employee based on the correlated business measures data and the correlated employee performance data.

13. The system according to claim 12, wherein the plurality of inputting devices comprise cell phones, keyboards and handheld personal devices.

14. The system according to claim 12, wherein the numerical business measures data are a plurality of different measures for the organization.

15. The system according to claim 12, wherein the display further provides for a plurality of charts, wherein each of the plurality of charts for the at least one employee represents a score that is based on one of the plurality of different business measures.

16. The system of claim 12, wherein the plurality of different business measures are based at least on organization income, organization revenue, organization customers and organization compliance.

17. The system of claim 12, wherein the plurality of different numerical performance goals data comprise individual performance goals, strength and development goals, development goals, individual company performance goals and project performance goals.

18. The system of claim 12, wherein the numerical business measures data comprise key business measures and project business files.

19. The system of claim 12, wherein the scale ranges from 3 to 7.

20. A computer readable storage media containing executable computer program instructions which when executed cause a processing system to perform a method comprising:
collecting a plurality of numerical performance goals data for the at least one employee and storing the plurality of numerical performance goals data in a database;
collecting numerical business measures data related to the organization and storing the numerical business measures data in the database;
normalizing the numerical performance goals data and the numerical business measures data to a common scale to generate normalized performance goals data and normalized business measures data;
correlating the normalized performance goals data and the normalized business measures data;
determining a plurality of scores for the performance of the at least one employee, wherein each of the plurality of scores are based on the correlated normalized performance goals data and the correlated normalized business measures data; and
displaying the plurality of scores on a display screen, wherein the screen provides a chart that is a visual indication of the plurality of scores representing an overall score for the performance of the at least one employee.
